(19) United States
(12) Patent Application Publication
(10) Pub. No.: US 2004/0236645 A1
(43) Pub. Date: Nov. 25, 2004

(54) Vendor-managed inventory system and method

(76) Inventor: Chih Yao Tien, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/853,061

(22) Filed: May 24, 2004

(30) Foreign Application Priority Data
May 23, 2003 (TW) 92114083

(51) Int. Cl. G06F 17/60

(52) U.S. Cl. 705/28

(57) ABSTRACT

A vendor-managed inventory system includes a VMI hub system (10), a buyer system (20), a plurality of vendor systems (30) and an external network (40) interconnecting all these systems. The VMI hub system stores and manages materials for the buyer system and the vendor systems, which can significantly reduce inventory control costs for the systems at the same time. The VMI hub system has a hub server (100) including a current period inventory setting module (1000), a material requirements information management module (1002), an inventory information processing module (1004), an alert signal generating module (1006), a delivery information management module (1008), and an inventory information updating module (1010). A related vendor-managed inventory method is also disclosed in the present invention.

### BACKGROUND OF THE INVENTION

1. Field of the Invention

The present invention relates generally to vendor-managed inventory, and especially to a vendor-managed inventory system and method for providing vendor-managed inventory services to a customer over an electronic communications network.

2. Background of the Invention

Vendor-managed inventory (VMI) is a business method which relates to vendor and customer interaction in an effort to minimize the customer's share of distribution costs and to eliminate inventory shortages associated with distributing a vendor's goods. Vendors that are able to reduce the customer's costs incurred in the purchase and distribution of the vendors' goods provide an added incentive for the customer to purchase more goods.

The art of automated vendor-managed inventory has been disclosed in patents such as US Pat. Publication No. 2003023503, entitled Vendor-managed Inventory Method and System and published on Jan. 30, 2003. This patent illustrates a vendor-managed inventory system based on a network environment, the VMI system comprising a vendor system, a buyer system and an external network interconnecting the two systems. The buyer system includes a buyer server, multiple workstations and manufacturing devices, a plurality of storage locations, and a sensor device. These entities of the buyer system are connected or linked through an internal network. Each storage location stores a small quantity of production material to be consumed by one of the manufacturing devices. The sensor device monitors quantities of materials at the storage locations via the internal network. When a quantity of any material falls below a specified threshold, the sensor device triggers an alert signal. The alert signal is then transferred to the buyer server, and material requirements information is generated and transmitted to the vendor system. Afterward, the required material is delivered to the buyer's premises by the vendor.

Although the system described above can reduce a level of stock for a buyer system, it cannot significantly lower inventory of a corresponding vendor. It is necessary that the vendor monitor a material consumption status of its customer at all times, and to have material stock on hand in order to timely supply the buyer. Therefore, the vendor is burdened with more inventory costs and management duties in controlling inventory of the supply chain. Accordingly, what is needed is an inventory system and method which can reduce inventory control costs for a buyer and its related vendors at the same time.

### SUMMARY OF THE INVENTION

A main objective of the present invention is to provide a vendor-managed inventory system and method that can reduce inventory control costs for a buyer and its vendors at the same time.

Another objective of the present invention is to provide a vendor-managed inventory system and method that can automatically generate alerts when a current stock of a material has fallen below a minimum inventory threshold, or has exceeded a maximum inventory threshold.

To accomplish the above objectives, a vendor-managed inventory (VMI) system in accordance with a preferred embodiment of the present invention comprises a VMI hub system, a buyer system, a plurality of vendor systems, and an external network interconnecting all these systems. The VMI hub system can store and manage materials for the buyer system and the vendor systems. The VMI hub system comprises a hub server which includes: a current period inventory setting module provided for calculating minimum inventory thresholds and maximum inventory thresholds of different materials for various periods, and setting current period inventory thresholds for various materials; an inventory information processing module provided for comparing a current stock of a material and its current period inventory thresholds, and determining whether the current stock of the material has fallen below a minimum inventory threshold, or exceeded a maximum inventory threshold; an alert signal generating module provided for generating a first alert signal when the current stock of the material has fallen below the minimum inventory threshold, or generating a second alert signal when the current stock of the material has exceeded the maximum inventory threshold; and a delivery information management module provided for generating a material replenishment record according to the first alert signal, or generating a notice according to the second alert signal.

Further, the present invention provides a preferred vendor-managed inventory method comprising the steps of: (a) updating inventory information of a material; (b) determining whether a current stock of the material has fallen below a predetermined minimum inventory threshold; (c) if the current stock of the material has fallen below the minimum inventory threshold: generating a first alert signal; (d) generating a material replenishment record, and sending the material replenishment record to a corresponding vendor system; and (e) receiving the material delivered by the vendor system, and generating a delivery record.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a schematic diagram of hardware configuration of a vendor-managed inventory system in accordance with the preferred embodiment of the present invention;

FIG. 2 is a schematic diagram of main function units of a hub server of the vendor-managed inventory system of FIG. 1; and

FIG. 3 is a flowchart illustrating a preferred method of implementing the vendor-managed inventory system.

### DETAILED DESCRIPTION OF THE INVENTION

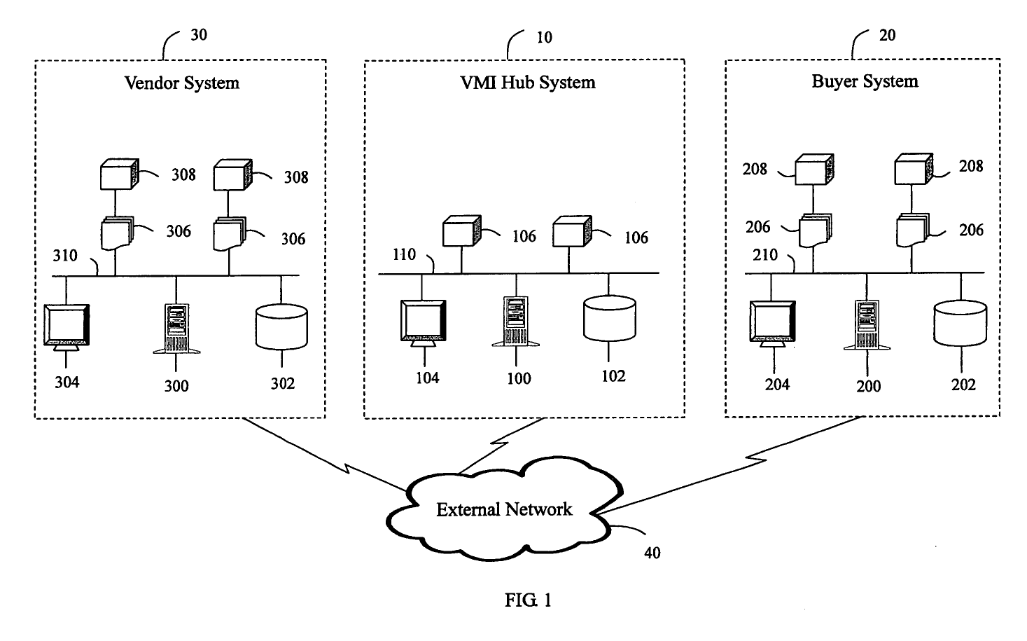

FIG. 1 is a schematic diagram of hardware configuration of a vendor-managed inventory (VMI) system in accordance with the preferred embodiment of the present invention. The vendor-managed inventory system comprises a VMI hub system 10, a buyer system 20, a plurality of vendor systems 30, and an external network 40 that interconnects all these systems. Only one vendor system 30 is shown in FIG. 1.

The VMI hub system 10 may be considered as an inventory management center for the vendor-managed inventory system of the present invention, and may partially function as a logistics center. The VMI hub system 10 can store and manage materials delivered by the vendor systems 30, receive material requirements information from the buyer system 20, and timely supply the buyer running the buyer system 20 with required materials. When a current stock of a certain material falls below a minimum inventory threshold for a current period, a material replenishment record is generated in the VMI hub system 10. The material replenishment record is transmitted to a corresponding vendor system 30 that provides such material, notifying the vendor running that vendor system 30 to supply the needed material. Moreover, when a current stock of a material exceeds a maximum inventory threshold for the current period, a notice is generated and transmitted to a corresponding vendor system 30. The notice notifies the vendor running the vendor system 30 not to deliver the material.

The material replenishment record may comprise information including a name, a quantity, specifications, and a delivery time of the material to be replenished. The minimum inventory thresholds and maximum inventory thresholds of a material for various periods are calculated according to production planning information sent from the buyer system 20, and according to business rules adopted by the VMI hub system 10. These kinds of business rules are well known and will be appreciated by those skilled in the art. The VMI hub system 10 is generally located in hub premises that are near the buyer, in order to timely deliver required materials to the buyer.

The VMI hub system 10 comprises a hub server 100, a hub database 102, a plurality of hub workstations 104 (only one shown), a plurality of hub warehouses 106, and a network 110 interconnecting all the above entities. The hub server 100 may execute various software applications to enable the entities of the VMI hub system 10 to communicate with each other as well as perform various enterprise level tasks. Such tasks include receiving material requirements information from the buyer system 20, and transmitting material replenishment records to the vendor systems 30. The software applications that can be executed by the hub server 100 include enterprise resource planning software, email software, database management software, and other tools commonly used in a business environment. The hub database 102 stores records used or generated by the VMI hub system 10, especially inventory-related records. The inventory-related records may include current stock records for various materials, records on minimum inventory thresholds and maximum inventory thresholds of different materials for various periods, material requirements information from the buyer system 20, material extraction records, and material replenishment records transferred to the vendor systems 30. A material extraction record is generated when the VMI hub system 10 extracts a material from one of the hub warehouses 106 to supply the buyer. The material extraction record comprises a name and specifications of the material, and an extraction quantity and a time of the extraction.

The hub workstations 104 may be general-purpose computer devices such as personal computers, laptops, portable handheld devices (e.g., personal digital assistants—PDAs), or other suitable devices known in the art. Each hub workstation 104 provides an interactive user interface for users of the VMI hub system 10 to carry out inventory management operations. The hub warehouses 106 store materials delivered by the vendor systems 30, in order to timely supply the buyer system 20 with required materials. The network 110 may be any suitable communications architecture needed for the VMI hub system 10, such as a local area network, wide area network, etc.

The buyer system 20 is typically a manufacturing plant or facility which consumes production materials stored in the VMI hub system 10, and comprises a buyer server 200, a buyer database 202, multiple buyer workstations 204 (only one shown), multiple buyer production devices 206, multiple supply containers 208 and a network 210 interconnecting all the above entities. The buyer server 200 may execute one or more computer programs to enable the entities of the buyer system 20 to communicate with each other, as well as perform various enterprise level tasks such as transferring material requirements information and production planning information to the VMI hub system 10. Typical computer programs that may be executed by the buyer server 200 include those for Materials Requirements Planning (MRP), Enterprise Resource Planning (ERP), billing, finance, and security.

The buyer database 202 stores records used or generated by the buyer system 20, especially material requirements information and production planning information. The buyer workstations 204 may be general-purpose computer devices such as personal computers, laptops, portable handheld devices, or other suitable computer processing devices. Each buyer workstation 204 provides an interactive user interface for users of the buyer system 20 to carry out inventory management operations. The buyer production devices 206 represent manufacturing or production machinery for producing products needed by customers. The supply containers 208 are located near the buyer production devices 206. Each supply container 208 stores a certain quantity of material to be consumed or expended by a corresponding buyer production device 206. When a quantity of a material stored in any of the supply containers 208 falls below a predetermined inventory threshold, a demand note is generated in the buyer server 200, and transferred to the VMI hub system 10. The demand note indicates that the material is running out and needs to be restocked. The predetermined inventory threshold is customarily determined by the buyer system 20 according to its own production planning, and the supply capacity and speed of the VMI hub system 10. The network 210 may be any suitable communications network needed for the buyer system 20, such as a local area network, wide area network, etc.

Each vendor system 30 comprises a vendor server 300, a vendor database 302, a plurality of vendor workstations 304 (only one shown), a plurality of vendor production devices 306, a plurality of storage locations 308, and a network 310 interconnecting all the above entities. The vendor server 300 may execute one or more computer programs to enable the entities of the vendor system 30 to communicate with each other, as well as perform various enterprise level tasks such as receiving material replenishment records and notices from the VMI hub system 10. The vendor database 302 stores records used or generated by the vendor system 30, especially material replenishment records and notices received from the VMI hub system 10, data on materials shipped to the hub premises, and current stocks of materials in the storage locations 308. The vendor workstations 304 may be general-purpose computer devices such as personal computers, laptops, portable handheld devices, or other suitable computer processing devices. Each vendor workstation 304 provides an interactive user interface for users of the vendor system 30 to carry out inventory management operations. The vendor production devices 306 represent manufacturing or production machinery for producing materials needed by the buyer system 20. The storage locations 308 store materials manufactured by the vendor production devices 306. The network 310 may be any suitable communications network needed for the vendor system 30, such as a local area network, wide area network, etc.

The VMI hub system 10, the buyer system 20 and the vendor systems 30 communicate with each other via the external network 40. The external network 40 may be any appropriate high-speed communications network known in the art, such as a private network or the Internet, and may include wireless technology and devices.

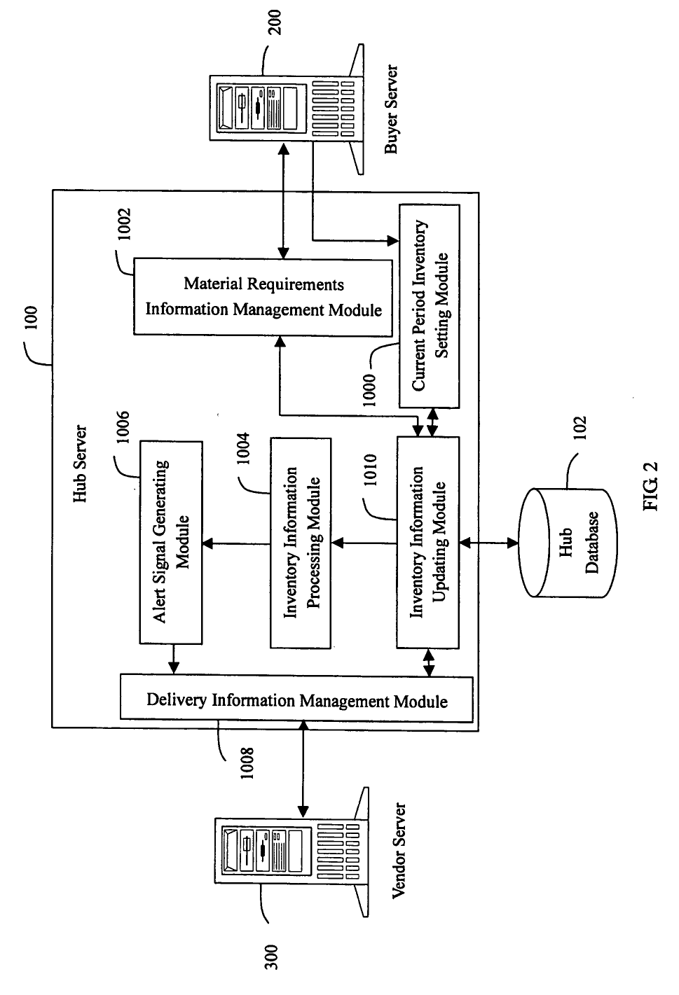

FIG. 2 is a schematic diagram of main function units of the hub server 100. The hub server 100 comprises a current period inventory setting module 1000, a material requirements information management module 1002, an inventory information processing module 1004, an alert signal generating module 1006, a delivery information management module 1008, and an inventory information updating module 1010.

The current period inventory setting module 1000 is provided for calculating minimum inventory thresholds and maximum inventory thresholds of different materials for various periods according to production planning information obtained from the buyer server 200 and according to adopted business rules, and setting current period inventory thresholds for various materials. The material requirements information management module 1002 is provided for receiving material requirements information from the buyer server 200, and generating material extraction records when the VMI hub system 10 extracts required materials from the hub warehouses 106 according to the material requirements information. The inventory information processing module 1004 is provided for comparing a current stock of a material with its current period inventory thresholds, and determining if the current stock of the material has fallen below a minimum inventory threshold or exceeded a maximum inventory threshold for the current period. The alert signal generating module 1006 generates a first alert signal when the current stock of the material has fallen below the minimum inventory threshold, and generates a second alert signal when the current stock of the material has exceeded the maximum inventory threshold. The delivery information management module 1008 is provided for generating a material replenishment record according to the first alert signal or a notice according to the second alert signal, and generating delivery records after the VMI hub system 10 receives materials delivered by the vendor systems 30. A delivery record may include a name, specifications, and a quantity of the material, and a time when the material is delivered. The inventory information updating module 1010 is provided for updating current stock records of materials stored in the hub database 102 according to the material extraction records and the delivery records.

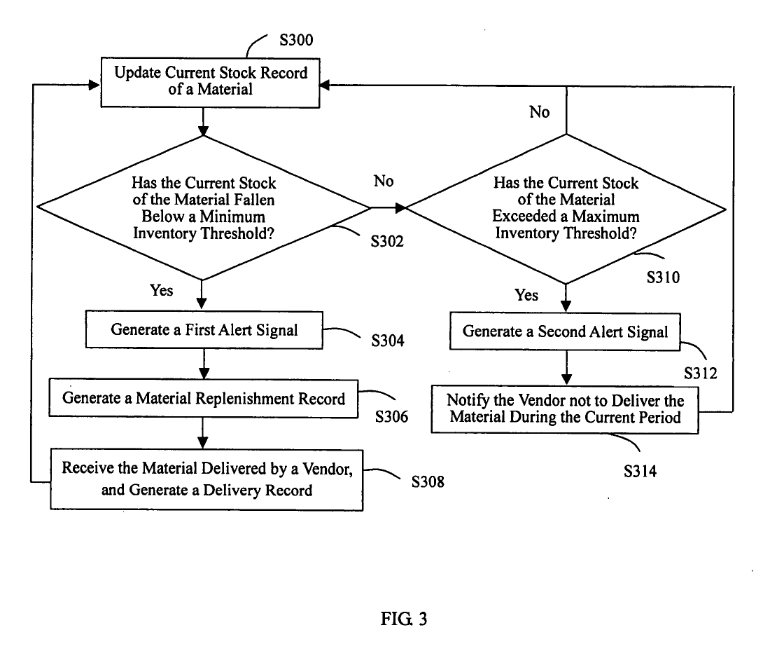

FIG. 3 is a flowchart illustrating a preferred method of implementing the vendor-managed inventory system. First, in step S300, when the VMI hub system 10 extracts a material from any of the hub warehouses 106 to supply the buyer system 20, or when any of the vendor systems 30 deliver a material to replenish stocks for the VMI hub system 10, the current stock of the material is changed. The relevant current stock record stored in the hub database 102 is updated timely by the inventory information updating module 1010. In step S302, the inventory information processing module 1004 automatically retrieves the updated current stock record as well as current period inventory thresholds of the material from the hub database 102, and determines whether the current stock of the material has fallen below a minimum inventory threshold for the current period. If the current stock of the material has not fallen below the minimum inventory threshold, the procedure goes directly to step S310 described below.

If the current stock of the material has fallen below the minimum inventory threshold, in step S304, a first alert signal is generated by the alert signal generating module 1006. The first alert signal is transmitted to the delivery information management module 1008, indicating that the material is running out and needs to be replenished. Afterward, in step S306, a material replenishment record is generated by the delivery information management module 1008 according to the first alert signal, and transferred to a corresponding vendor system 300 that provides such material. The vendor server 300 notifies operators located at the vendor workstations 304 to deliver the material according to the material replenishment record. In step S308, a delivery record is generated by the delivery information management module 1008 when the VMI hub system 10 accepts the delivered material. The current stock record of the material stored in the hub database 102 is updated according to the delivery record, and the procedure returns to step S300.

In step S310, the inventory information processing module 1006 compares the current stock and a predetermined maximum inventory threshold for the current period. If the current stock does not exceed the maximum inventory threshold, the procedure returns to step S300 described above. If the current stock exceeds the maximum inventory threshold for the current period, in step S312, a second alert signal is generated by the alert signal generating module 1006, and transferred to the delivery information management module 1008. In step S314, a notice is generated by the delivery information management module 1008. The notice is transmitted to a corresponding vendor system 30 that provides such material, advising that there is no need for delivery of the material during the current period. Thereafter, the procedure returns to step S300.

Although the present invention has been specifically described on the basis of a preferred embodiment and preferred method, the invention is not to be construed as being limited thereto. Various changes or modifications may be made to said embodiment and method without departing from the scope and spirit of the invention.

What is claimed is:

1. A vendor-managed inventory (VMI) system for providing vendor-managed inventory services over an electronic communications network, the system comprising a VMI hub system, a buyer system, a plurality of vendor systems and an external network which interconnects all these systems, wherein the VMI hub system comprises a hub server, the hub server comprising:
a current period inventory setting module provided for calculating minimum inventory thresholds and maximum inventory thresholds of different materials for various periods, and setting current period inventory thresholds for various materials;
an inventory information processing module provided for comparing a current stock of a material and its current period inventory thresholds, and determining if the current stock of the material has fallen below a minimum inventory threshold or exceeded a maximum inventory threshold;
an alert signal generating module provided for generating a first alert signal when the current stock of the material has fallen below the minimum inventory threshold, or generating a second alert signal when the current stock of the material has exceeded the maximum inventory threshold; and
a delivery information management module provided for generating a material replenishment record according to the first alert signal, or generating a notice according to the second alert signal.

2. The system according to claim 1, wherein the delivery information management module is further provided for generating a delivery record after the VMI hub system receives the material delivered by a corresponding vendor system.

3. The system according to claim 1, wherein the hub server further comprises a material requirements information management module provided for receiving material requirements information from the buyer system, and generating material extraction records when the VMI hub system extracts required materials from its warehouse to supply the buyer system.

4. The system according to claim 1, wherein the hub server further comprises an inventory information updating module provided for updating the current stock record of the material according to the material extraction record and the delivery record.

5. The system according to claim 1, wherein the VMI hub system further comprises a hub database for storing records used or generated by the VMI hub system.

6. The system according to claim 5, wherein said stored records include current stock records for various materials, records on minimum inventory thresholds and maximum inventory thresholds of different materials for various periods, material requirements information, material extraction records, and material replenishment records.

7. The system according to claim 1, wherein the VMI hub system further comprises a plurality of hub workstations, each providing an interactive user interface for users of the VMI hub system to perform inventory management operations.

8. The system according to claim 1, wherein the VMI hub system further comprises a plurality of hub warehouses provided for storing materials delivered by the vendor systems in order to timely supply the buyer system with required materials.

9. The system according to claim 1, wherein the minimum inventory thresholds and maximum inventory thresholds of different materials for various periods are calculated according to production planning information obtained from the buyer system, and according to business rules adopted by the VMI hub system.

10. The system according to claim 1, wherein the buyer system comprises a buyer server provided for transmitting production planning information and material requirements information to the VMI hub system.

11. The system according to claim 1, wherein each of the vendor systems comprises a vendor server provided for receiving the material replenishment record and the notice sent from the VMI hub system.

12. A computer-based vendor-managed inventory method, comprising the steps of:
updating inventory information of a material;
determining whether a current stock of the material has fallen below a minimum inventory threshold; and
if the current stock of the material has fallen below the minimum inventory threshold:
generating a first alert signal;
generating a material replenishment record, and sending the material replenishment record to a corresponding vendor system; and
receiving the material delivered by the vendor system, and generating a delivery record.

13. A computer-based vendor-managed inventory method, comprising the steps of:
updating inventory information of a material;
determining whether a current stock of the material has fallen below a minimum inventory threshold; and
if the current stock of the material has not fallen below the minimum inventory threshold:
determining whether the current stock of the material has exceeded a maximum inventory threshold; and
if the current stock of the material has exceeded the maximum inventory threshold:
generating a second alert signal; and
generating a notice transferred to a corresponding vendor system in order to notify the vendor not to deliver the material for a current period.

14. The method according to claim 13, further comprising the steps of:
receiving production planning information from a buyer system;
calculating minimum inventory thresholds and maximum inventory thresholds of different materials for various periods according to the production planning information and business rules; and
setting a minimum inventory threshold and a maximum inventory threshold for each material for a current period.

15. The method according to claim 13, further comprising the step of updating the current stock record of the material according to the delivery record.
